(19) United States
(12) Patent Application Publication
(10) Pub. No.: US 2017/0306679 A1
(43) Pub. Date: Oct. 26, 2017

(54) DOOR SYSTEM TO PROVIDE CHECK FUNCTION AND ASSIST DOOR CLOSING AND OPENING IN A VEHICLE

(71) Applicant: Ford Global Technologies, LLC, Dearborn, MI (US)

(72) Inventor: Nathan Gregory Smith, Werribee South (AU)

(21) Appl. No.: 15/484,955

(22) Filed: Apr. 11, 2017

(30) Foreign Application Priority Data
Apr. 21, 2016 (CN) 201610250790.8

(51) Int. Cl. E05F 3/20; E05F 15/60; E05D 5/02; E05D 11/10

(52) U.S. Cl. CPC E05F 3/20; E05D 11/1028; E05F 15/60; E05D 5/0207

(57) ABSTRACT

A door system to provide a check function and door closing assistance in a vehicle is provided. The door system comprises a door hinge, a clip assembly attached to the door hinge and a door closing assist device disposed adjacent to the door hinge. The door hinge includes a body leaf fixed to a body of the vehicle, and a door leaf attached to a door of the vehicle and configured to be movable relative to the body leaf and the door leaf includes an engagement member. The clip assembly includes a check member having a distal end and a base end and the check member includes at least a first check portion adjacent to the distal end and a second check portion adjacent to the base end.

### RELATED APPLICATION

This application claims the benefit of Chinese Patent Application No.: CN 201610250790.8 filed on Apr. 21, 2016, the entire contents thereof being incorporated herein by reference.

### FIELD

The present application relates to a door system in a vehicle, more specifically, relates to a door system to provide check function and assist door closing and/or opening.

### BACKGROUND

A door of a vehicle is usually designed to go through a check position before it can be fully opened. A check arm system is used to hold the door open in a specific angle, or in the check position. The conventional check arm system uses two metallic or elastomer spring units enclosed in a check arm housing and a check arm includes a ramp portion. The spring unit includes a slider adjacent to the check arm. The check arm is coupled to a clevis on a vehicle body and the door. The spring units are disposed opposite the check arm. During a door opening event, the ramp slides through the check arm housing and compresses the springs by pressing the sliders into the housing. The vertical load applied on the sliders by the spring causes friction and makes a door operator feels as a drag to move the door at this position, which sets up a check position. The compression of the spring stores potential energy. During a door closing event, the potential energy is released.

The inventor has recognized that check arm system introduces a large load on both the slider and the ramp interface and the friction thus created requires a sufficient force to overcome. The ramp itself, along with the friction, forces the load to non-perpendicular to an axis of the slider, but slightly off center, which can lead to wear of the slider and the check arm housing and can result in potential for noise during operation. Additionally, the check arm system is complex because of its multiple components and the need to attach the hardware associated with the check arm device to the door.

### SUMMARY

According to one aspect of the present disclosure, a door system to provide a check function and door closing assistance in a vehicle is provided. The door system may comprise a door hinge, a clip assembly and a door closing assist device. The door hinge may include a body leaf fixed to a body of the vehicle, and a door leaf attached to a door of the vehicle and configured to be movable relative to the body leaf. The door leaf may include an engagement member. The clip assembly may be attached to the door hinge, may include a check member having a distal end and a base end. The check member may include at least a first check portion adjacent to the distal end and a second check portion adjacent to the base end. The door closing assist device may be disposed adjacent to the door hinge to assist door closing. The door closing assist device may provide a force between a door and a body of the vehicle when a door is close to a closed position. The clip assembly may be coupled to the door hinge, and the door is arranged in a first check position when the engagement member is positioned in the first check portion and the door is arranged in a second check position when the tongue is positioned in the second check portion.

In one embodiment, the door closing assist device may include a magnet and the magnet may be disposed on the door.

In another embodiment, the door closing assist device may include a magnet and the magnet is fastened to the body leaf of the door hinge.

According to another aspect of the present disclosure, a door closing assist device in a vehicle is provided. The door closing assist device may comprise at least one magnet disposed adjacent to a door hinge; and at least one fastening member for securing the magnet to an attaching location in the vehicle. The magnet may have a pull force to assist door closing.

In one embodiment, the magnet may be disposed on the door and may be secured to a door of the vehicle by the fastening member, and the magnet may have the pull force in a range of approximately between about 40 and 170 pounds.

In another embodiment, the magnet may be secured to a body leaf of a door hinge by the fastening member, and wherein the magnet has the pull force in a range of approximately between about 40 and 170 pounds.

In another embodiment, the door closing assist device may comprise two magnets and two fastening members.

In another embodiment, the magnet may be a permanent magnet.

In another embodiment, the magnet may be an electromagnet.

In another embodiment, the electromagnet may be supplied with a current to create magnetic field when a door closing is detected.

According to another aspect of the present disclosure, a door system in a vehicle is provided. The door system may comprise at least one electromagnet disposed adjacent to a door hinge; at least one fastening member for securing the magnet to an attaching location in the vehicle, a battery electrically connected the electromagnet to supply a current, a motion sensor, and a controller to control the battery to supply the current to the electromagnet to generate magnetic field to assist door closing or door opening in response to a signal from the motion sensor.

In one embodiment, the magnetic field has a force in a range of approximately between about 40 and 170 pounds.

In another embodiment, the magnetic field generated may push a door open when the door opening is detected.

In another embodiment, the magnetic field may be generated pulls a door close when the door closing is detected.

In another embodiment, the magnetic field may be only generated during the door closing event and the door opening event

According to another aspect of the present disclosure, a door hinge assembly in a vehicle is provided. The door hinge assembly may comprise a door hinge and a clip assembly attached to the door hinge. The door hinge may include a body leaf fixed to a body of the vehicle, a door leaf attached to a door of the vehicle and movable relative to the body leaf, and the door leaf may include an engagement member. The clip assembly may include a check member having a distal end and a base end, the check member may include at least a first check portion adjacent to the distal end and a second check portion adjacent to the base end. The clip assembly may be coupled to the door hinge, and the door is in a first check position when the engagement member of the door leaf is positioned in the first check portion and the door is in a second check position when the engagement member of the door leaf is positioned in the second check portion.

In one embodiment, the door may be half open at a predetermined angle at the first check position and may be fully open at the second check position.

In another embodiment, the check member may be a sinuous strap, the first check portion may include a first recessed portion and the second check portion may include a second recessed portion. The clip assembly may include a body, and the sinuous strap may be disposed at least partially around a periphery of the body and the base end of the sinuous strap may be fixed to the body. The engagement member of the door leaf may include a tongue.

In another embodiment, a distance between the first recessed portion and the second recessed portion may define an angle at which the door is half open in the first check position.

In another embodiment, the sinuous strap may be formed from a flat strap, the first recessed portion may include a first valley formed adjacent to the distal end, the second recessed portion may include a second valley formed adjacent to the base end.

In another embodiment, the sinuous strap may be formed from a flat strap, the first recessed portion may include a first valley formed adjacent to the distal end, the second recessed portion may include a slanted portion, a flat portion and a stop substantially perpendicular to the flat portion.

In another embodiment, the distal end may include a guide surface extending from the first valley in a direction downward from a top surface of the base.

In another embodiment, the door leaf of the door hinge may include a plate, and the tongue may extend substantially perpendicularly from the plate toward the clip assembly disposed under the plate. The body leaf may include a mounting portion attached to the body of the vehicle and an arm substantially perpendicular to the mount portion and having an outer surface. During a door opening event, the tongue passes the distal end of the sinuous strap, the first recessed portion and is stopped at the second recessed portion as the door moves from a closed position to a full opened position.

In another embodiment, a magnet may be disposed on the outer surface of the arm of the body leaf to assist door closing.

In another embodiment, the magnet may have a pull force in a range of approximately between about 40 and 170 pounds.

According to another aspect of the present disclosure, a clip assembly is provided. The clip assembly provides check function for a door and is mounted in a door hinge. The clip assembly may comprise a base, and a check member arranged at least partially around a periphery of the body. The check member may include a base end attached to the body, a distal end, a first check portion adjacent to the distal end of the check member, and a second check portion adjacent to the base end. A door is held in a half-opened position at a predetermined angle when an engagement member of the door hinge is positioned in the first check portion, and the door is held in a fully-opened position when the engagement member is positioned in the second check portion.

In one embodiment, the check member may include a sinuous strap formed of a flat strap. The first check portion may include a first recessed portion and the second check portion may include a second recessed portion, and a top surface of the sinuous strap and a top surface of the base may face a same direction, and the sinuous strap may be made of spring steel.

In another embodiment, the check member may include a substantially flat section along a length direction of the sinuous strap and the flat section may be disposed between a sinuous strap and the base. A distal segment of the flat section and a base segment of the flat section may be attached to the body and a middle segment may be spaced away from the base.

In another embodiment, the first recessed portion may include a valley adjacent to the distal end, and the second recessed may include a flat portion, a slanted portion of a ridge of the sinuous strap, and a stop protruding from the flat portion.

In another embodiment, the distal end may include a guide surface extending from the valley in a direction downward from the top surface of the base.

In another embodiment, the sinuous strap may include three ridges each having rounded tops. The first recessed portion may include a first valley between the first ridge and the second ridge, and the second recessed portion may include a second valley between the third ridge and a stop disposed adjacent to the base end

In another embodiment, the sinuous strap may include a middle portion between the first recessed portion and the second recessed portion, a distance between the first recessed portion and the second recessed portion may define an angle at which the door is half open in the first check position.

It should be understood the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a plan view of an example embodiment of a door hinge assembly to provide a check function and door closing assistance implemented in a door system in a vehicle, schematically illustrating a door in a closed position.

FIG. 2 is a plan view of the door hinge assembly of FIG. 1, schematically illustrating the door in a half open position.

FIG. 3 is a plan view of the door hinge assembly of FIG. 1, schematically illustrating the door in a full open position.

FIG. 4 is a sectional view of the example embodiment of the door system of FIG. 1 taken along line A-A in FIG. 1, showing an example of a door closing assist device.

FIG. 5 shows an example embodiment of a door closing assist device.

FIG. 6 is a block diagram of an example vehicle system 300 in which an example door closing and opening assist device 320 may be implemented.

FIG. 7 is a perspective view of an example embodiment of a door hinge assembly, schematically illustrating the door hinge assembly in a first check position.

FIG. 8 is a perspective view of the door hinge assembly of FIG. 7, schematically illustrating the door hinge assembly in a second check position.

FIG. 9 is a perspective view of an example embodiment of a clip assembly.

FIG. 10 is a top view of the clip assembly of FIG. 9.

FIG. 11 shows a relationship of the torque with the door opening angle in a door closing process and a door opening process, respectively, illustrating a check arm system with a spring and a door system of the present disclosure.

FIG. 12 shows a relationship of the potential energy with the door opening angle, illustrating the door system energy contribution in a check arm system with a spring and a door assembly of the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Example embodiments of the present disclosure will now be described more fully with reference to the accompanying drawings, in which example embodiments are shown. Example embodiments of the present disclosure may, however, be embodied in many different forms and should not be construed as being limited to the embodiments set forth herein; rather, these embodiments are provided so that this disclosure will be thorough and complete, and will fully convey the concept of example embodiments to those of ordinary skill in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise.

Unless otherwise defined, all terms (including technical and scientific terms) used herein have the same meaning as commonly understood by one of ordinary skill in the art to which example embodiments of the present disclosure. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

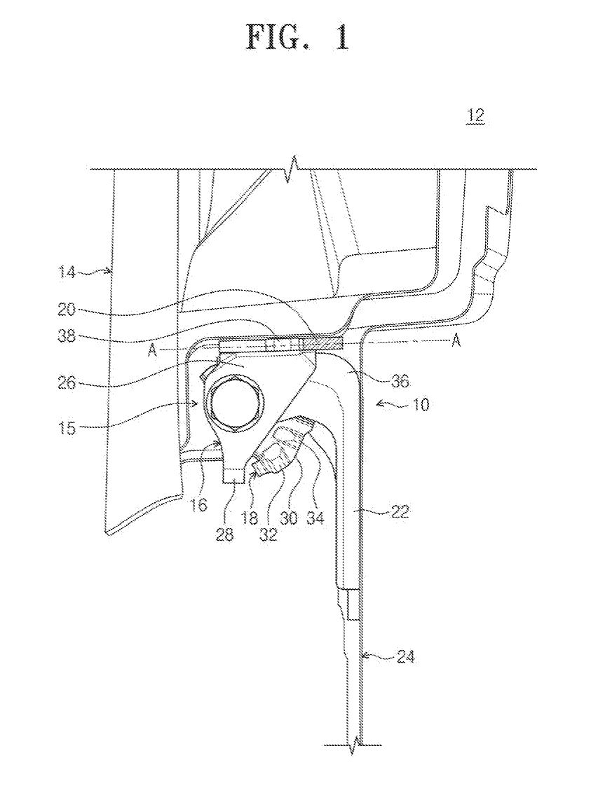

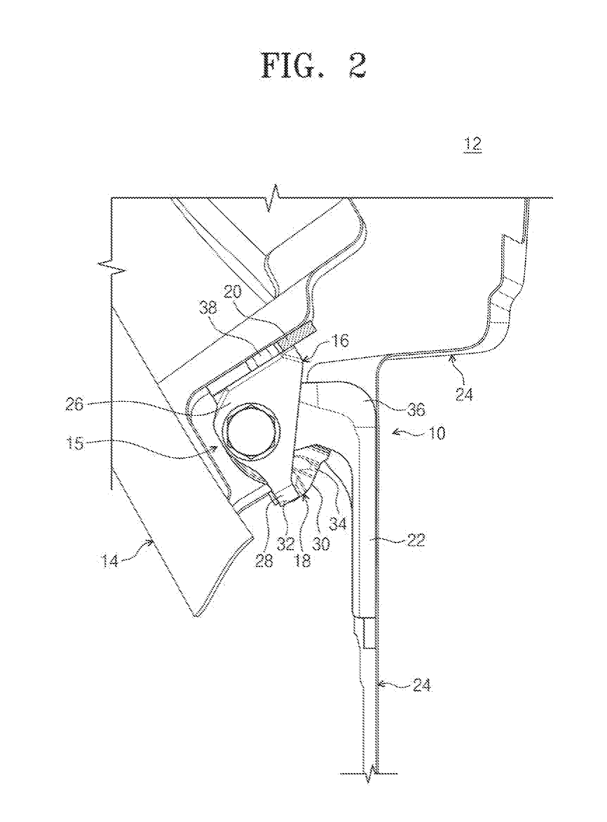

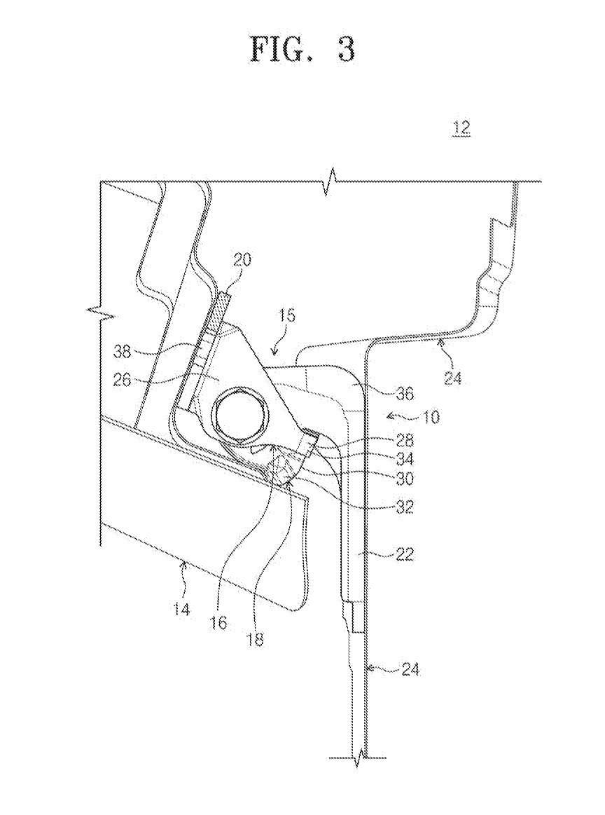

FIGS. 1 to 3 are a plan view of an example embodiment of a door hinge assembly 15 to provide a check function and door closing assistance implemented in a door system 10 of vehicle 12. FIG. 1 schematically illustrates a door 14 in a closed position, FIG. 2 schematically illustrates the door 14 in a half open position and FIG. 3 schematically illustrates the door 14 in a full open position. The door system 10 may include the door hinge assembly 15 and a door closing assist assembly 20. The door hinge assembly 15 may include a door hinge 16, a clip assembly 18. The door hinge 16 may include a body leaf 22 fixed to a body 24 of the vehicle 12 and a door leaf 26 attached to the door 14. The door leaf 26 may be mounted to the door 14 by a fastener including a bolt 38 and may be movable relative to the body leaf 22 during the door opening and closing events. The door leaf 26 may include an engagement member 28 extending toward the clip assembly 18. The engagement member 28 may be a tongue to be engaged with a check member 30 of the clip assembly 18.

The clip assembly 18 may include the check member 30 having a first check portion 32 and a second check portion 34 to provide a first check position and a second check position, respectively. The check positions are illustrated in FIG. 2 and FIG. 3. In the door closed position illustrated in FIG. 1, the tongue 28 is not engaged with the check member 30. As the door opens, the tongue 28 moves toward and into the check member 30. In the half opened door position illustrated in FIG. 2, the tongue 28 engages with the first check portion 32 of the check member 30 and is retained in the first check portion 32. As the door opens further from the first check position, the tongue 28 is released from the first check portion and moves into the second check portion 34. In the full opened door position illustrated in FIG. 3, the tongue 28 engages with the second check portion 34 of the check member 30. The tongue 28 cannot be moved further in a direction of the door opening when it is retained in the second check portion 34. That is, the door cannot be opened further. As described above, the check function of the door system is provided by the clip assembly 18.

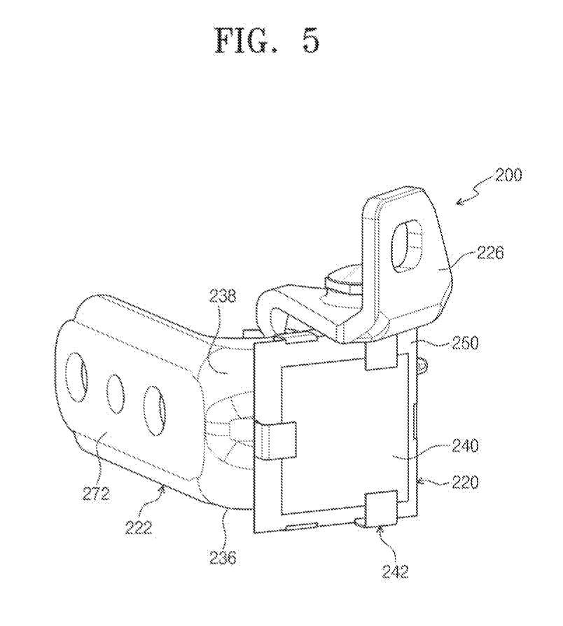

FIG. 1 further shows that the door closing assist assembly 20 is disposed adjacent to door hinge 16 and between the door 14 and the body leaf 22. In some embodiments, the door closing assist assembly 20 may be disposed at least partially overlapping an arm 36 of the body leaf 22 in the door closed position. In the embodiment depicted in FIGS. 1-3, the door closing assist assembly 20 may be mounted on the door 14. In some embodiments, the door closing assist assembly 20 may be mounted on the door hinge 16 as described in detail in FIG. 5.

In some embodiments, the door closing assist assembly 20 may include a magnet. The magnet may be a permanent magnet or an electromagnet. During the door closing, the magnet provides a force between the door 14 and the body 24 to assist the door closing. For example, referring to FIGS. 1-3, as the door moves from the fully open position in FIG. 3 to the half-open position and then to the closed position, the magnet becomes closer to the body 24 or the body leaf 22. The magnetic field generated between the magnet and the body 24 pulls the door 14 to move toward the body and thus facilitates the door closing.

The door closing assist assembly 20 may be configured to have sufficient force to assist the movement of the door 14. In some embodiments, door closing assist assembly 20 may include a magnet that has a pull force in a range approximately between about 40 to 170 pounds. In one example, the door closing assist assembly 20 may include a permanent magnet with specification of Neodymium magnet (N48-52). In another example, the door closing assist assembly 20 may include an electromagnet providing a pull force in force in a range approximately between about 40 to 170 pounds. It should be appreciated that the range of the pull force described in this application is an example. The magnet may have any range of the pull force that is sufficient to assist the door closing and the door opening.

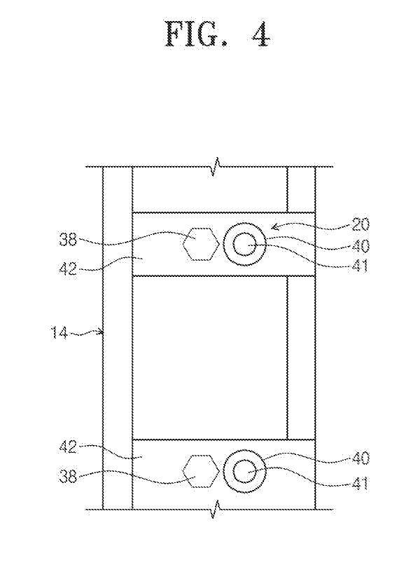

FIG. 4 is a sectional view of the example embodiment of the door system of FIG. 1 taken along line A-A in FIG. 1, schematically showing positioning of a door closing assist assembly 20 on the door 14. The door closing assist assembly 20 may include at least one magnet 40. In the depicted embodiment, the door closing assist assembly 20 includes two magnets 40. The magnets 40 may be disposed adjacent to the door hinge 16 (also see FIGS. 1-3). As shown in FIG. 4, the magnet 40 is disposed adjacent to the bolts 38 that secures the door hinge 16 to the door 14. In some embodiments, the magnet 14 may be mounted on the door 14 in a door hinge zone 42. The door hinge zone 42 may include a reinforced area so that the magnet 40 may be secured to the door hinge zone 42 by a fastening member. In some embodiments, the magnet may be disposed on an area that at least partially overlaps with the arm 36 of the body leaf 22 when the door 14 is closed. In other words, when the door 14 is in a closed position, the magnet 40 may be positioned between the door 14 and the body leaf 22 of the door hinge as illustrated in FIG. 1. It should be appreciated that the magnets 40 may be disposed in any suitable positions of the door in a manner to generate desired force to assist the door closing.

In the depicted embodiment in FIG. 4, the magnet 40 has a round shape. It should be appreciated that the magnet 40 may have any suitable shapes. For example, the magnet 40 may be configured to be a nut-like shape with threads inside a hole and may be fastened to the door by a screw 41. It should be appreciated that the magnets may be secured to the door 14 using any suitable method. For example, the magnets 40 may be disposed in a recess on the door and is secured to the door by the magnetic force.

FIG. 5 shows an example embodiment of a door hinge assembly 200 including a door closing assist assembly 220. The door hinge assembly 200 may include a door leaf 226, a body leaf 222 and the door closing assist assembly 220. The body leaf 222 may include a mounting portion 272 and an arm 236 having an outer surface 238. The door closing assist assembly 220 may be disposed on the outer surface 238 of the arm 236. In some embodiments, the door closing assist assembly 220 may include a permanent magnet 240 and a fastener 242 to secure the permanent magnet 240 to the body leaf 222. In the depicted embodiment, the fastener 242 includes a panel 250 and a plurality of clips. The magnet 240 is secured by the plurality of clips. It should be appreciated that the magnet may have any suitable shape and may be secured to the body leaf 222 by any suitable approach.

Referring back to FIGS. 1-3, when the door 14 moves toward the body 24 during the door closing event, an edge of the door 14 moves to the arm 36 of the body. In other words, the door moves toward the magnet 240 on the door leaf 222 during the door closing event. When the door moves closed to the door, the magnet force is generated between the door and the body leaf 222 or the body and thus facilitating the door closing.

It should be appreciated that the door closing assist assembly 220 may include an electromagnet that is electrically connected with an electrical source or a battery. The electromagnet may be secured to the body leaf by any suitable method and disposed on any suitable position that generate desired magnetic field during the door closing process.

In some embodiments, the door system may include at least one door closing assist assembly 220 disposed on one door hinge assembly. In some embodiments, the door system may include two door closing assist assembly 220 disposed on two door hinge assemblies.

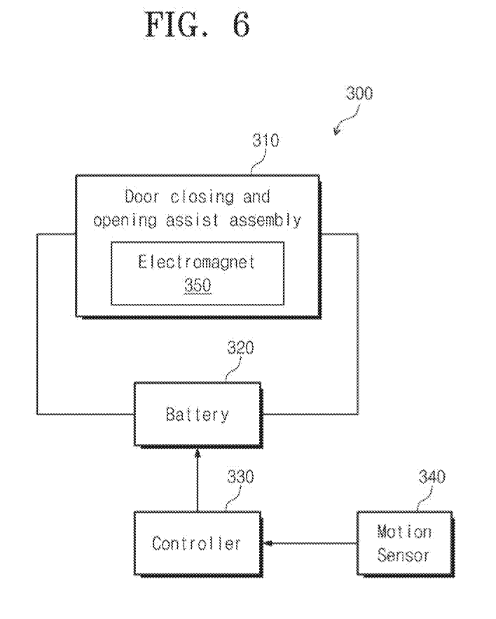

FIG. 6 is a block diagram of an example door closing and opening assist system 300 implemented in a vehicle. The door closing and opening assist system 300 may include a door closing and opening assist assembly 310, a battery 320, a controller 330 and a motion sensor 340. The door closing and opening assist assembly 310 may include at least one electromagnet 350 disposed adjacent to a door hinge of the vehicle. As described above, in some embodiments, the electromagnet 350 may be disposed on a door closed to the door hinge. In some embodiments, the electromagnet 350 may be disposed on a door hinge assembly. The electromagnet may consist of a magnetic core made from a ferromagnetic or ferromagnetic material such as iron and a number of turns wound around the magnetic core. The magnet field may be generated from the electromagnet 350 by supplying a current from the battery 320. The electromagnet 350 may be configured to generate a magnet force to move the door. In some embodiments, a force of the electromagnet may be in a range of 40 to 170 pounds. The polarity of the electromagnet 350 may be configured to be varied.

The controller 330 may be configured to control the battery 320 to supply the current to the electromagnet 350 based on movement of the door detected by the motion sensor 340. For example, the motion sensor may be an accelerometer. In some embodiments, the movement of the door may be detected indirectly. In one example, a signal that an interior light is on may be sent to the controller to energize the electromagnet. In another example, the motion sensor may be a detection switch that determines the location of the door (e.g., a door switch that turns light on) or a proximity switch. The motion sensor may be any suitable sensor that can detect an opening and closing of the door and/or indicate the door is moving.

When the door closing event is detected by the motion sensor 340, the controller 330 may control the battery 320 to supply a current to the electromagnet 350 to generate magnetic field that pulls the door in a closed direction.

In some embodiments, the polarity of the electromagnet 350 may be reversed compared to the polarity during the door closing event. When the door opening is detected by the motion sensor 340, the controller 330 may control the battery 320 to supply a current to the electromagnet 350 to generate the magnetic field that push the door in an opening direction. In this manner, the electromagnet 350 may facilitate the door opening.

In some embodiments, the current may be only supplied to the electromagnet when the motion is detected. In other words, the magnetic field from the electromagnet 350 is generated only during the door closing and opening events. In some embodiments, the current may be supplied when the door is closed to the body of the vehicle at a first predetermined angle during the closing event. In some embodiments, the current may be supplied when the door is about to open and may be stopped when the door opens to a second predetermined angle. The first predetermined angle may be the same as or different from the second predetermined angle.

The controller 330 may be an individual unit or may be integrated with the vehicle control system. The motion sensor 340 may be a sensor specifically configured for the door closing and opening assist system or may be a sensor present in the vehicle and used for other purposes.

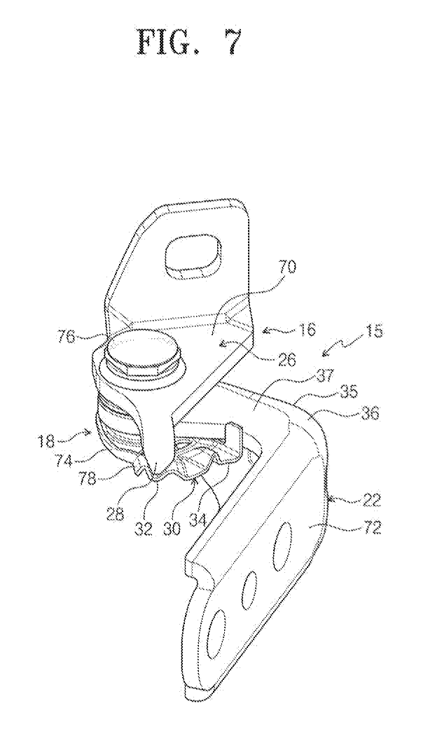

FIG. 7 is a perspective view of an example embodiment of the door hinge assembly 15 in the door system of FIGS. 1-3, schematically illustrating the door hinge assembly in a first check position. The first check position corresponds a half door opening position illustrated in FIG. 2. The door hinge assembly 15 may include a door hinge 16 and a clip assembly 18. The door hinge 16 may include a body leaf 22 and a door leaf 26. In some embodiments, the door leaf 26 may include a plate 70 and an engagement member 28 extending substantially perpendicularly from the plate 70 toward the clip assembly 18. The body leaf 22 of the door hinge 16 may include a mounting portion 72 and an arm 36 that may be substantially perpendicular to the mounting portion 72. In some embodiments, the arm 36 may include an arm portion 35 and a support portion 37. The arm portion 35 may extend from the mounting portion 72 and may be substantially perpendicular to the mounting portion 72. The support portion 37 may extend from an edge of the arm portion 35 and substantially parallel to the plate 70. The plate 70 of the door leaf 26 may be disposed on the support portion 37.

The clip assembly 18 may include a check member 30 and a base 74 to which the check member 30 is attached. The plate 70, the arm 36 and the base 74 may be coupled together by a fastener 76 while the door leaf 26 may be rotated around the fastener 76. In other words, the door leaf 26 may be configured to be movable relative to the body leaf 22 or the clip assembly 18. In some embodiments, the fastener 76 may include a bolt and a nut. It should be appreciated the door leaf 16, the body leaf 22 and the clip assembly 18 may be coupled with any suitable mechanism and may have any suitable configuration that enables the movement of the door leaf relative to the body leaf and the clip assembly.

The door leaf 16 may include an engagement member 28 extending substantially perpendicular from the plate 70. In some embodiments, the engagement member 28 may be a tongue. In some embodiments, the door hinge assembly 15 may be configured such that the tongue 28 may be engaged with the check member 30 when the tongue is positioned above check portions of the check member 30. In some embodiments, the check member 30 may include a guide portion 78 adjacent to the first check portion 32. The guide portion 78 may include a guide surface that may be inclined down at a steady slope from the check member 30 in a direction away from the first check portion 32, or the guide surface may be inclined as convex shape or a concave shape. The guide portion 78 may facilitate the movement of the tongue 28 into and out of the check member 30 during a door opening event. For example, the tongue is not in contact with the check member 30 when the door is closed (see FIG. 1). During the door opening event, the tongue 28 moves toward the check member 30 and the guide portion 78 may guide the tongue 28 to move into the check member 30 and then positioned in the first check portion 32. When the tongue is in the first check portion 32, the door is in a first check position. In some embodiments, the door may be half open at a predetermined angle at the first check position. The angle may be determined by a positioning of the first check portion 32 in the clip assembly or in the door hinge assembly 15. The tongue 28 is moved away from the first check portion 32 when the door is further opened. The door goes through the first check position before it is open all the way to the full open position. In this way, the door hinge assembly 15 can provide a check function.

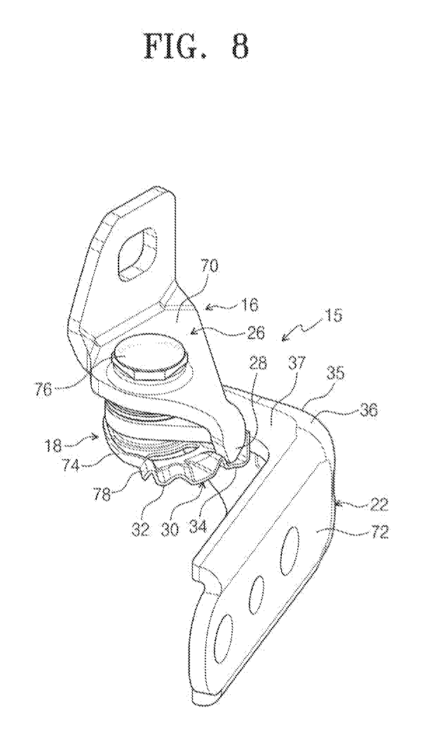

FIG. 8 is a perspective view of the door hinge assembly 15 of FIGS. 1-3, illustrating the door hinge assembly 15 in a second check position. For the sake of brevity, the elements and features similar to those previously shown and described will not be described in further detail. Referring to FIGS. 2-3 and 7-8, as the door further opens, the tongue 28 is released from the first check portion 32 and moves toward the second check portion 34 of the check member 30. When the tongue 28 is in the second check portion 34, the door is in a second check position. At the second check position, the door is fully open. The second check portion 34 of the check member 30 may be configured to stop the tongue 28 to move further in a direction of the door opening while allow the movement in a direction of the door closing. In the depicted embodiment, the second check portion 34 may be disposed adjacent to the arm 36 of the door leaf 22. In the second check position, the tongue 28 cannot move further in a direction of the door opening. That is, the door cannot be opened further at the second check position. The second check portion 34 of the check member defines the maximum angle that the door opens.

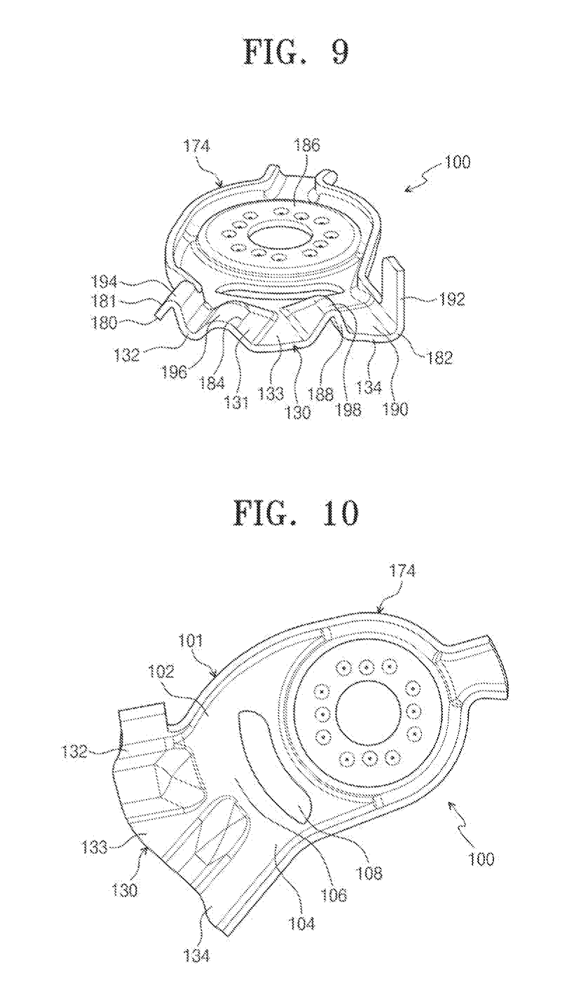

Referring to FIGS. 9-10, FIG. 9 shows a perspective view of an example embodiment of a clip assembly 100 and FIG. 10 is a top view of the clip assembly of FIG. 9. The clip assembly 100 may include a base 174 and a check member 130. The clip assembly 100 may be coupled to a door hinge. The check member 130 may be engaged with an engagement member of the door hinge to provide at least two check positions. In some embodiments, the check member 130 may include a first check portion and a second check portion. A door of the vehicle may be half open at a first check position when the first check portion is engaged with the engagement member, and the door may be fully open at a second check position when the second check portion is engaged with the engagement member.

In some embodiments, the check member 130 may include a sinuous strap 131 having a distal end 180 and a base end 182. The first check portion may include a first recessed portion 132 adjacent to the distal end 180 and the second check portion may include a second recessed portion 134 adjacent to the base end 182. In some embodiments, the sinuous strap 131 may include a middle portion 133 between the first recessed portion 132 and the second recessed portion 134. A distance between the first recessed portion 132 and the second recessed portion 134 or the position of the first recessed portion 132 in the door hinge assembly may determine the first check position for the door.

The sinuous strap 131 may be disposed at least partially around a periphery of the base 174. A top surface 184 of the sinuous strap and a top surface 186 of the base 174 may face a same direction. The base end 182 may be attached to the base 174. The sinuous strap 131 may be configured and attached to the base 174 in a manner that the sinuous strap 131 may have sufficient strength to sustain a force transmitted from the engagement member of the door hinge while maintaining flexibility to retain and release the engagement member. In some embodiments, other portions of the sinuous strap 131 may be attached to the base 174 in addition to the attachment of the base end 182. For example, a portion of the sinuous strap 131 adjacent to the distal end 180 may be attached the base 174. In another example, a middle portion of the sinuous strap 131 may be attached to the base 174. In this way, the check member 130 may possess desired strength and flexibility.

In some embodiments, the check member 130 may include a substantially flat section 101 along a length direction of the sinuous strap 131 and the flat section 101 may be disposed between the sinuous strap 131 and the base 174. The flat section 101 may include a distal segment 102, a base segment 104 and a middle segment 106. The distal segment 102 and the base segment 104 may be attached to the base 174, respectively while the middle segment 106 may be spaced away from the base 174 to form a gap 108. In some embodiments, the base 174, the flat section 100 and the sinuous strap 131 may be integrally formed in a mold.

In some embodiments, the sinuous strap 131 may be formed from a flat strap. The distal end 180 may include a guide portion 181 extending downward and away from the first recessed portion 132.

In some embodiments, the first recessed portion 132 may include a first valley formed adjacent to the distal end 180 and the second recessed portion 134 includes a second valley formed adjacent to the base end 184.

In some embodiments, the first recessed portion 132 may include a first valley formed adjacent to the distal end 182 and the second recessed portion 134 may include a slanted portion 188, a flat portion 190 and a stop 192 that is substantially perpendicular to the flat portion 190. The stop 192 can prevent the engagement member of the door hinge to move further in a direction of a door opening.

In some embodiments, the sinuous strap 131 may include three ridges 194, 196 and 198 each having rounded tops. The first recessed portion 132 may include a first valley between the first ridge 194 and the second ridge 196, and the second recessed portion 134 may include a second valley between the third ridge 198 and the stop 192. The rounded ridges enable smooth movement of the engagement member of the door hinge on the sinuous strap 131 while providing retaining and releasing function along with the valleys.

In some embodiments, the sinuous strap 131 may be made from spring steel. It should be appreciated that the sinuous strap may be made from any suitable material that may provide flexibility to enable the engagement member of the door hinge to move in and out of the sinuous strap and move along the sinuous strap while possessing sufficient strength to sustain the force applied from the door hinge.

It should be appreciated that the check member may have various configurations. For example, the first check portion may be configured in any suitable form to retain and release the engagement member of a door leaf of a door hinge. The second check portion may be configured in any suitable form to retain the engagement member, release the engagement in one direction and stop the movement of the engagement member in an opposite direction. In one example, a release and retain feature may include a ramp and then a flat portion instead of the multiple waves. The check member may include a plurality of the release and retain features like this structure. In this way, the door can be held at a plurality of the locations and do not move away from the set location from an operator.

The clip assembly provides check function to the vehicle door, and thus the conventional check arm device is not needed. Since the clip assembly is incorporated in a door hinge assembly, no additional space, hardware and reinforcement on the door are needed for accommodation of the clip assembly.

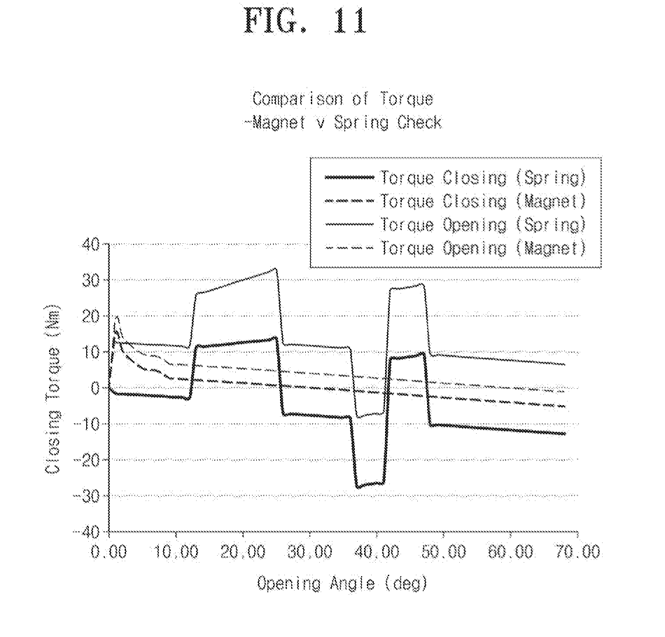

FIG. 11 shows a relationship of the torque to move the door with the door opening angle in a door closing event and a door opening event, respectively, illustrating a conventional check arm system including a spring device to assist door closing and a magnet-assisted door closing system of the present disclosure. FIG. 11 shows that the torque required to close and open the door is much lower during the door closing and opening events in the magnet assisted door closing system compared to the spring assisted door closing in the check arm system. Further, the change of the torque with the opening angle is consistent except an early peak in the magnet assisted door closing system. The early peak is offset in the system by the seal compression around the door, reducing the effect of the early torque peak on initial opening effort.

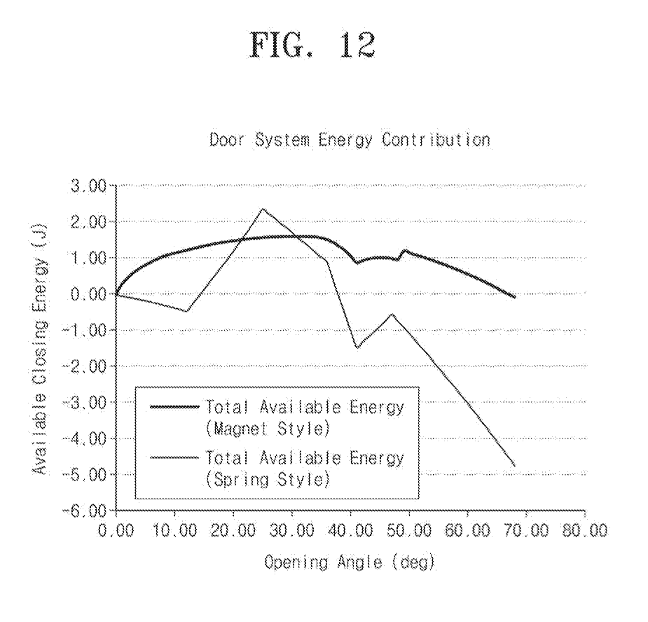

FIG. 12 shows a relationship of the potential energy available to a user or a door operator with the door opening angle, illustrating the energy contribution during a range of door motion in a conventional check arm system with a spring device to assist door closing (spring style) and a magnet-assisted door closing system (magnet style) of the present disclosure. In the magnet-assisted door closing system, the magnets provide a force between a door and a body of a vehicle, with the offset from the hinge axis creating a torque when the magnets are close to the closed position and thus close the body leaf. The potential energy is gained in the first few opening degrees as the magnet only applies force over a limited distance. As the magnet is non-contact, there is no friction to overcome during the rest of the opening cycle. The door provides potential energy due to the hinge axis tip, which is offset by the frictional loss of the hinges.

In the conventional check arm system, the door potential energy is offset by hinge friction as in the magnet-assisted door closing system. In the check arm system, the potential energy of the spring is fully stored by approximately twenty-four (24) open degrees. Once this occurs, the high frictional force contributes a high frictional loss over the rest of the opening cycle, which causes the overall available potential energy to reduce over the rest of the opening cycle. There is also low available energy at low opening angles due to the spring having no compression available to store potential energy at this point. Despite the low spring compression state, there is still have some vertical load to eliminate noise, which contributes further friction losses to the system.

As can been seen from FIG. 12, the potential energy available to a user in the magnet-assisted door closing system is positive substantially throughout the range of the door movement, whereas the potential energy becomes rapidly less effective after the maximum compression of the spring in the check arm system. In other words, the magnet-assisted door closing system has greater available closing potential energy under a wider range of door motion range while maintaining a minimal opening torque requirement compared to the check arm system.

The door closing assist system of the present system can facilitate the door closing as demonstrated by the experiments. In the experiments, two magnets with Neodymium N52 specification were used in the door closing assist system. Each of the magnets has a diameter of 1 inch and a thickness of one half inch with a small hole in the center. The magnets are disposed on a door of a vehicle and adjacent to a door hinge. Four door systems were tested. System 1 includes a clip assembly of the present disclosure without a door assist assembly (i.e., without magnets). System 2 includes a clip assembly of the present disclosure and a door assist assembly (i.e., with magnets). System 3 includes a conventional check arm. System 4 includes a conventional check arm and a door assist assembly of the present disclosure (i.e., with magnets). The experiments were conducted during trials when the window was up and the window was down. Table 1 shows the results of the experiments with window up. Table 2 shows the results of experiments with window down.

TABLE 1

| | System 1 | System 2 | System 3 | System 4 |
|---|---|---|---|---|
| | without | with | without | with |
| | magnets | magnets | magnets | magnets |
| Door closing | 4.4 | 3.75 | 4.2 | 3.8 |
| energy (Joules) | | | | |

| | | |
|---|---|---|
| Chang in energy | 0.65 | 0.4 |
| (Joules) | | |

TABLE 2

| | System 1 | System 2 | System 3 | System 4 |
|---|---|---|---|---|
| | without | with | without | with |
| | magnets | magnets | magnets | magnets |
| Door closing | 2.1 | 1.5 | 2.1 | 1.8 |
| energy (Joule) | | | | |

| | | |
|---|---|---|
| Chang in energy | 0.6 | 0.3 |
| (Joule) | | |

In System 1 and System 2, Table 1 shows that the energy required to close the door is decreased by 0.65 Joules in System 2 compared to System 1. Table 2 shows that the energy required to close the door is decreased by 0.6 Joule in System 2 compared to System 1. That is, the average energy required to close the door is decreased by approximately 0.63 Joule in the system 2 including magnets as compared with the door systems 1 without the magnets.

In System 3 and System 4, Table 1 shows that the energy required to close the door is decreased by 0.4 Joule in System 4 compared to System 3. Table 2 shows that the energy required to close the door is decreased by 0.3 Joule in System 4 compared to System 3. That is, the average energy required to close the door is decreased by approximately 0.35 Joule in the system 4 including magnets as compared with the door systems 3 without the magnets.

It can be seen that the door closing assist assembly of the present disclosure reduces the energy required to close the door. Further, the door closing effort was improved more significantly in the door system having the clip assembly to provide a check function of the present disclosure compared to the check arm system.

The door closing assist assembly including permanent magnets does not have significant effect on the door opening effort as demonstrated by the experiment on the handle force. In a door system with no magnet and no conventional check arm, a maximum handle force to open the door is 13 Newton, which results from gravity working on the door plus the friction of the system. In a door system with a door closing assist assembly of the present disclosure (i.e., magnets), a maximum of the handle force to open the door is 16 Newton. In a conventional check arm door system, the handle force to open the door is 24 Newton. The experiment shows that the magnets' influence over the maximum force to open the door is lower than that in the conventional check arm design.

The door system of the present disclosure has various advantageous. For example, the door closing assist assembly includes magnets which are simple in structure and can be secured to a zone of door hinge which has been reinforced. As such, there is no additional processing on the vehicle needed for accommodation of the door closing assist assembly. Since a clip assembly in the door hinge can provide a check function, the conventional check arm device can be eliminated. The clip assembly with the check function can be mounted in a door hinge, which further saves the reinforcement plates and other hardware associated with the check arm device.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and subcombinations of the various structures, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

The invention claimed is:

1. A door system to provide a check function and door closing assistance in a vehicle, comprising:
a door hinge including:
a body leaf fixed to a body of the vehicle, and
a door leaf attached to a door of the vehicle and configured to be movable relative to the body leaf, wherein the door leaf includes an engagement member;
a clip assembly attached to the door hinge, wherein the clip assembly includes a check member having a distal end and a base end and wherein the check member includes at least a first check portion adjacent to the distal end and a second check portion adjacent to the base end; and
a door closing assist device disposed adjacent to the door hinge to assist door closing,
wherein the door closing assist device provides a force between a door and a body of the vehicle when a door is close to a closed position, and
wherein the clip assembly is coupled to the door hinge, and wherein the door is arranged in a first check position when the engagement member is positioned in the first check portion and the door is arranged in a second check position when the tongue is positioned in the second check portion.

2. The door system of claim 1, wherein the door closing assist device includes a magnet and the magnet is disposed on the door.

3. The door system of claim 1, wherein the door closing assist device includes a magnet and the magnet is fastened to the body leaf of the door hinge.

4. The door system of claim 2, wherein the door closing assist device includes two magnets and two fastening members to secure the magnets to the door respectively.

5. A door closing assist assembly in a vehicle, comprising:
at least one magnet disposed adjacent to a door hinge; and
at least one fastening member for securing the magnet to an attaching location in the vehicle,
wherein the magnet has a pull force to assist door closing.

6. The door closing assist assembly of claim 5, wherein the magnet is disposed on the door and is secured to a door of the vehicle by the fastening member, and wherein the magnet has the pull force in a range of approximately between about 40 and 170 pounds.

7. The door closing assist assembly of claim 5, wherein the magnet is secured to a body leaf of a door hinge by the fastening member, and wherein the magnet has the pull force in a range of approximately between about 40 and 170 pounds.

8. The door closing assist assembly of claim 5, comprising two magnets and two fastening members.

9. The door closing assist assembly of claim 5, wherein the magnet is a permanent magnet or an electromagnet.

10. A door hinge assembly in a vehicle, comprising:
a door hinge including:
a body leaf fixed to a body of the vehicle,
a door leaf attached to a door of the vehicle and movable relative to the body leaf, wherein the door leaf includes an engagement member,
a clip assembly attached to the door hinge, wherein the clip assembly includes a check member having a distal end and a base end, and wherein the check member includes at least a first check portion adjacent to the distal end and a second check portion adjacent to the base end,
wherein the clip assembly is coupled to the door hinge, and wherein the door is in a first check position when the engagement member of the door leaf is positioned in the first check portion and the door is in a second check position when the engagement member of the door leaf is positioned in the second check portion.

11. The door hinge assembly of claim 10, wherein the door is half open at a predetermined angle at the first check position and is fully open at the second check position.

12. The door hinge assembly of claim 10, wherein the check member includes a sinuous strap, the first check portion includes a first recessed portion and the second check portion includes a second recessed portion, and wherein the clip assembly includes a body, wherein the sinuous strap is disposed at least partially around a periphery of the body and the base end of the sinuous strap is fixed to the body, and wherein the engagement member of the door leaf includes a tongue.

13. The door hinge assembly of claim 12, wherein the sinuous strap is formed from a flat strap, the first recessed portion includes a first valley formed adjacent to the distal end, the second recessed portion includes a slanted portion, a flat portion and a stop substantially perpendicular to the flat portion.

14. The door hinge assembly of claim 12, wherein the sinuous strap includes a middle portion between the first recessed portion and the second recessed portion, and wherein a distance between the first recessed portion and the second recessed portion defines an angle at which the door is half open in the first check position.

15. The clip assembly of claim 12, wherein the sinuous strap includes a first, a second and a third ridges each having rounded tops, wherein the first recessed portion includes a first valley between the first ridge and the second ridge, and the second recessed portion includes a second valley between the third ridge and a stop disposed adjacent to the base end.

16. The clip assembly of claim 12, wherein the check member includes a substantially flat section along a length direction of the sinuous strap and the flat section is disposed between a sinuous strap and the base, wherein a distal segment of the flat section and a base segment of the flat section are attached to the base and a middle segment is spaced away from the base.

17. The door hinge assembly of claim 13, wherein the distal end includes a guide surface extending from the first valley in a direction downward from a top surface of the base.

18. The door hinge assembly of claim 12, wherein the door leaf of the door hinge includes a plate, wherein the tongue extends substantially perpendicularly from the plate toward the clip assembly disposed under the plate,
wherein the body leaf includes a mounting portion attached to the body of the vehicle and an arm substantially perpendicular to the mount portion and having an outer surface,
wherein, when fully opening the door, the tongue passes the distal end of the sinuous strap, the first recessed portion and is stopped at the second recessed portion as the door moves from a closed position to a full opened position.

19. The door hinge assembly of claim 18, wherein a magnet is disposed on the outer surface of the arm of the body leaf to assist door closing.

20. The door hinge assembly of claim 18, wherein the magnet has a pull force in a range of approximately between about 40 and 170 pounds.
